(19) United States
(12) Patent Application Publication
(10) Pub. No.: US 2013/0333293 A1
(43) Pub. Date: Dec. 19, 2013

(54) Side Load Constant Force Counterbalance System

(71) Applicant: Caldwell Manufacturing Company North America, LLC, Rochester, NY (US)

(72) Inventors: Jay Sofianek, Webster, NY (US); Patrick Milligan, Rochester, NY (US); Allen Feltes, Rochester, NY (US); Alan Jakus, Hemlock, NY (US)

(21) Appl. No.: 13/919,534

(22) Filed: Jun. 17, 2013

Related U.S. Application Data
(60) Provisional application No. 61/660,433, filed on Jun. 15, 2012.
(60) Provisional application No. 61/660,355, filed on Jun. 15, 2012.

(51) Int. Cl. E05D 13/00

(52) U.S. Cl. CPC E05D 13/12
USPC 49/430; 49/506

(57) ABSTRACT

A side load constant force window balance assembly is disclosed. The balance assembly has a spring member, a spring housing, and a carrier module. The spring housing and carrier module are coupled to the spring member. The carrier module is configured to support a portion of a window sash and has an engagement feature configured to selectively engage the window frame.

### CROSS-REFERENCE TO RELATED APPLICATIONS

This application claims the benefit of U.S. Provisional Application No. 61/660,433, filed on Jun. 15, 2012 and U.S. Provisional Application No. 61/660,355, filed on Jun. 15, 2012. The entire disclosure of the above applications is incorporated herein by reference.

### FIELD

The present teachings relate to a coil spring counter balance assembly for a window and, more particularly, to a fixed spring counter balance assembly for a movable sash window.

### BACKGROUND

A window assembly generally includes a window frame, at least one sash, and a pair of opposing window jambs with each jamb having a channel for allowing the vertical travel of the sash. The sash is attached to a balance which assists with the raising and lowering of the sash by providing a force to counterbalance the weight of the sash.

The jambs are part of the window frame and are positioned on either side of the sash. The jamb channels must provide adequate clearance to permit the sash support, also known as a carrier, to freely traverse up and down within them. The movement of the sash with respect to a fixed spring assembly causes friction and can damage internal surfaces within the channel. This permits detritus from the damaged channel to flow through the jamb channel to impair the movement of the sash and interfere with a spring support mechanism.

Windows are subject to manufacturing guidelines that specify air flow standards for various designs. For example, there are a variety of standards which apply depending upon the region of the country to which the window is to be shipped for installation. Not only must the sash panes be able to structurally withstand high air pressures, but the various moving elements of each window frame must be able to move freely.

Previous attempts to alleviate the problem with springs and counterbalance assemblies within the jamb channels of window frames have failed to achieve the desired result. What is needed is a structure that successfully achieves the goal of reducing the amount of interaction between the spring and sash that is within a jamb channel. This objective preferably would be achieved while not increasing friction which might add to the burden of moving the sash up and down through the jamb channel.

### SUMMARY

The present invention relates to a counter balance system for a window sash within a window frame. The system has a spring counter balance with a cassette having a coiled spring disposed therein. The cassette is configured to be selectively fixably couple to the window frame. Coupled to a movable end of the coiled spring is a window sash support member. The window sash support member is movable from a first window support location to a second window support location. The window support member has a locking feature configured to be rotated from a first position to a second position, wherein in the second position, the locking feature is disposed within a hole defined within the window frame. The hole has a bearing surface which engages the locking feature. In one embodiment, the window sash support member has a rotatable flange having a locking protrusion which holds the locking feature in a non-engaged position.

According to another embodiment, the rotatable flange has an engageable member which is configured to accept forces to move the locking feature from a non-engaged position to an engaged position.

According to another embodiment, the rotatable locking feature has a pair of rotatable flanges which interact with first and second surfaces in the frame.

According to the above embodiment, the support member includes a translatable member configured to engage the rotatable member and move the first and second rotatable flanges from unengaged to engaged positions.

### BRIEF DESCRIPTION OF THE FIGURES

FIGS. 1A-1C represent a spring counter balance for a removable sash installation according to the present teachings;

FIGS. 2A-2C represent the spring counter balance shown in FIGS. 1A-1C in a stowed position;

FIGS. 3A-3C represent views of the spring counter balance shown in FIGS. 2A-2C in a removed position according to the present teachings;

FIGS. 4A and 4B represent perspective and side views of a spring counter balance according to the present teachings;

FIGS. 5A and 5B represent perspective and side views of an alternate spring counter balance according to the present teachings;

FIGS. 6A and 6B represent perspective and end views of the sash support shown in FIGS. 5A and 5B;

FIGS. 7A-7G represent an alternate spring counter balance according to the present teachings;

FIGS. 8A-8G represent an alternate spring counter balance according to the present teachings;

FIGS. 9A-9G represent a spring housing according to the present teachings;

FIGS. 10A-10C represent a second spring housing according to the present teachings;

FIGS. 11A-12G represent views of a sash support member according to the present teachings;

FIGS. 13A-13C represent rotatable hook members used in the sash support members shown in FIGS. 1A-3C; and

FIG. 14 depicts a window assembly having a movable sash and counter balance spring.

### DETAILED DESCRIPTION OF THE DRAWINGS

Although the present teachings show counter balance in a single hung sash, the teachings herein are equally applicable to double hung windows.

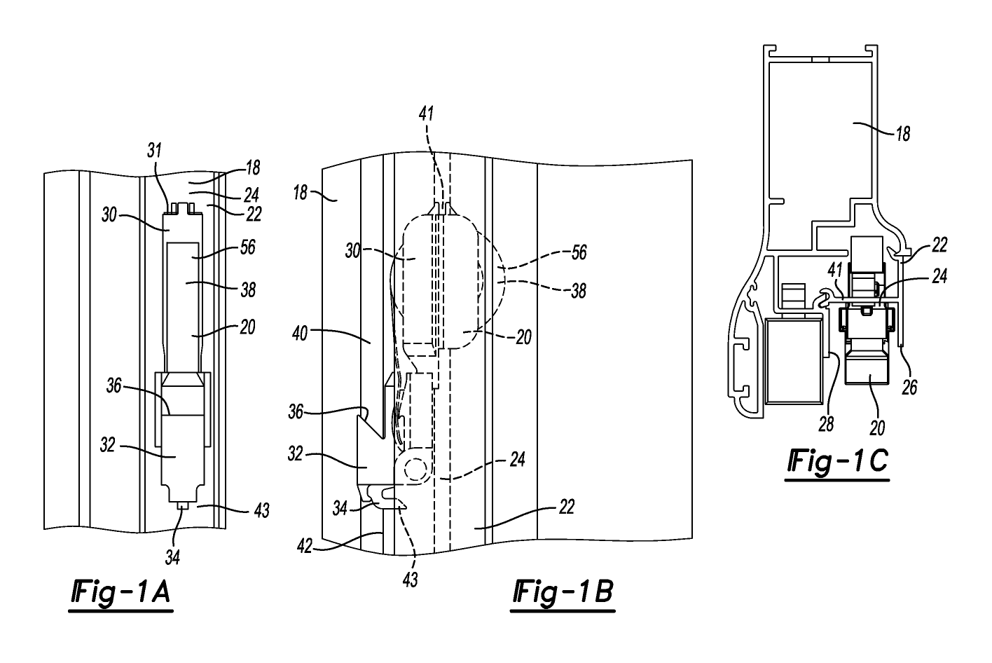

Referring to FIGS. 1A-1C, there is shown a window support assembly 18. The window assembly has a frame 22 which slidably supports a sash (not shown). To prevent the effects of gravity on the sash, a spring counter balance 20 is provided. The spring counter balance 20, which is shown in a retracted position, is coupled to the window frame 22 and provides forces to support the sash.

The spring counter balance 20 is positioned within the frame 22, and is fixably coupled to a first bearing surface 24. In this regard, a portion of the spring counter balance 20 is positioned within a carrier aperture 41 defined within the first bearing surface 24. As seen in FIG. 1C, the spring counter balance 20 is disposed between channel forming surfaces 26, 28. As will be described in more detail below, the spring counterbalance 20 can be fixed within the aperture 41 using flanges and/or one or more fasteners.

The spring counter balance 20 is generally divided into three members: the spring housing 30, the spring 38, and the carrier module or sash support 32. The spring housing 30 is positioned with the carrier aperture 41, functions to couple the spring 38 to the first bearing surface 24 and, as described below, has features to facilitate the coupling and reduce the profile of the spring counter balance 20. The spring counter balance 20 defines an internal compartment which surrounds and rotationally supports the coil spring 38. The compartment generally supports the spring coil 56 in a manner to allow the spring 38 to be fixed at a first end within the spring housing. A portion of the spring 38 can rotate within the housing on a curved bearing surface to allow extraction of the spring during movement of the sash.

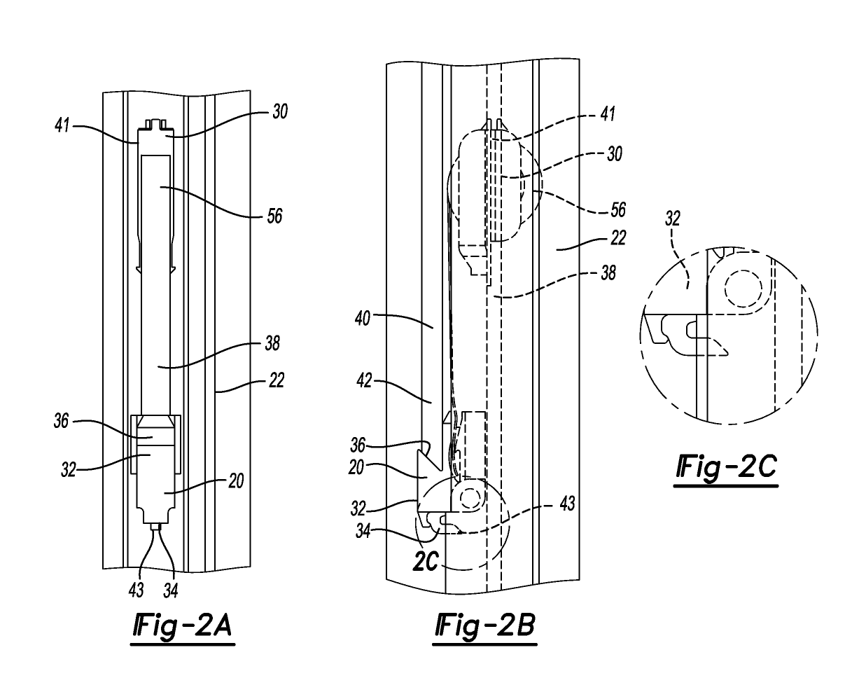

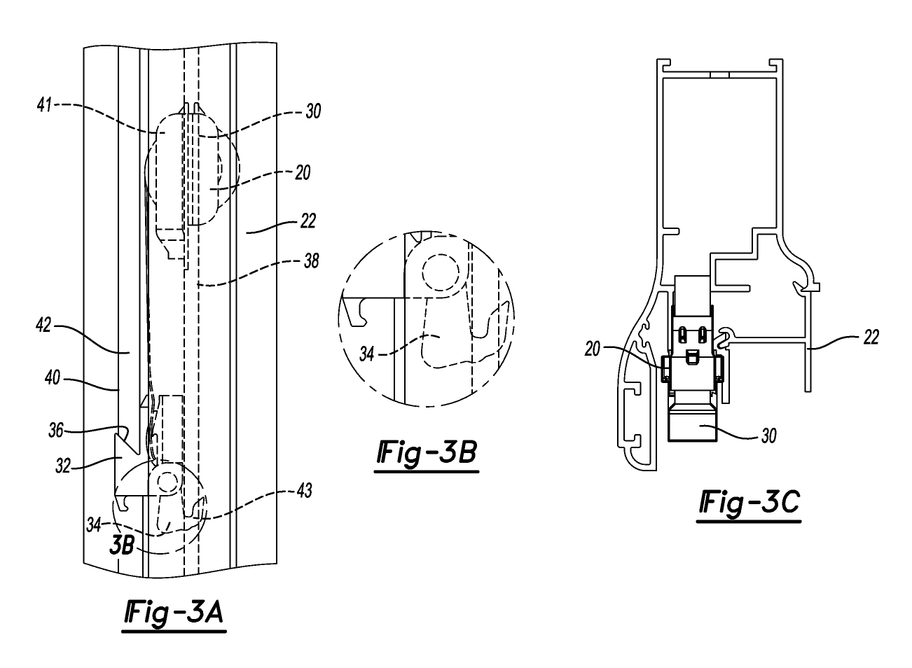

A second end of the spring 38 is fixably coupled to the sash support 32. The sash support 32 is translatably movable within the frame 22 so as to provide a force onto the sash to overcome the effects of gravity. As shown in FIGS. 2A-3B, the sash support 32 has a locking feature 34 that is movable from a disengaged position 40 to an engaged position 42. In the disengaged position, the sash support 32 is lined up with a frame coupling aperture 43. At the frame coupling aperture 43, a consumer can rotate the locking feature 34 into the frame coupling aperture 43 to selectively lock the sash support 32 to the window frame 22. This releases the force of the spring from the sash, thus allowing a consumer to, for example, remove the sash from the frame for cleaning. It is envisioned that there could be a number of frame coupling apertures along the length of the track to allow for selective disengagement of the sash support 32 from the sash.

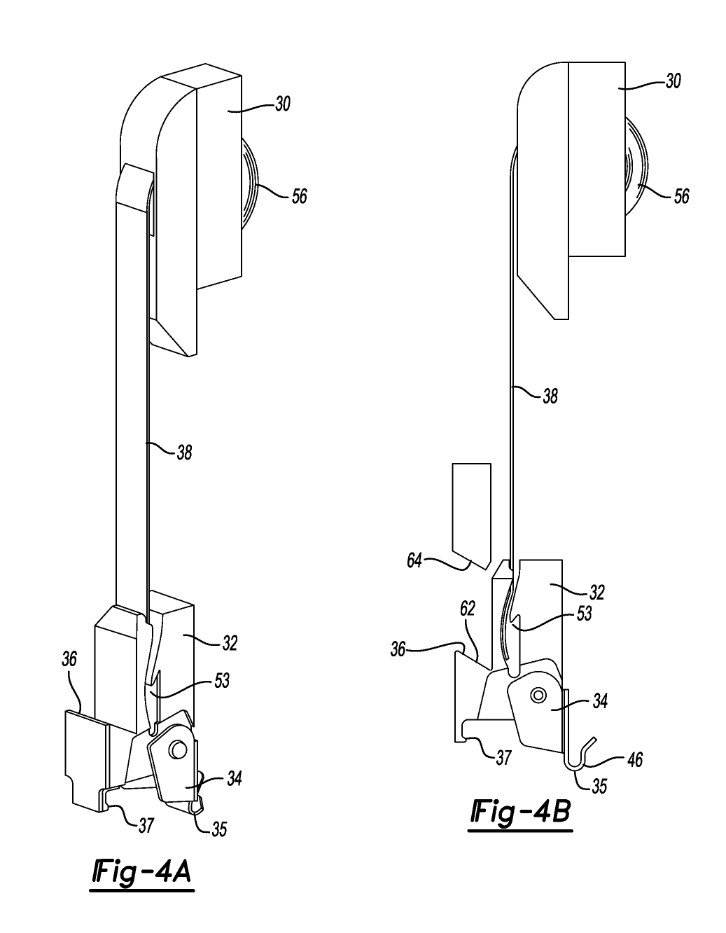

As shown in FIGS. 4A and 4B, the sash support 32 has a sash support feature 36 which engages a coupling surface 64 that forms part of the sash, such as a tab portion that is integrally formed in and protrudes from the frame of the sash. Alternatively, the coupling surface 64 can be formed on a separate component (e.g., a block) that is attached to the frame of the sash. While the coupling surface can take a number of configurations, it is envisioned that the coupling surface 64 can be coplanar or complementary with the surface of the support feature 68 when engaged. The sash support 32 has a spring coupling channel 53 which couples a second end of the spring 38 to the sash support 32. Moreover, It is envisioned other coupling mechanisms such as locking flanges, fasteners, or adhesives could be used to couple the second end of the spring to the sash support 32.

Also shown is an alternate locking feature 34 which has a u-shaped coupling flange configured to surround and couple to a bearing flange on the sash support 32. The u-shaped flange is rotatably coupled to the bearing flange by a pin. The locking feature 34 has a hook 46 which engages an aperture formed in the window frame. The hook also has an engaging surface 35 that engages a lock 37 on the support sash body. The lock 37 can have a curved engagement surface to interlock with a curved surface on the locking member.

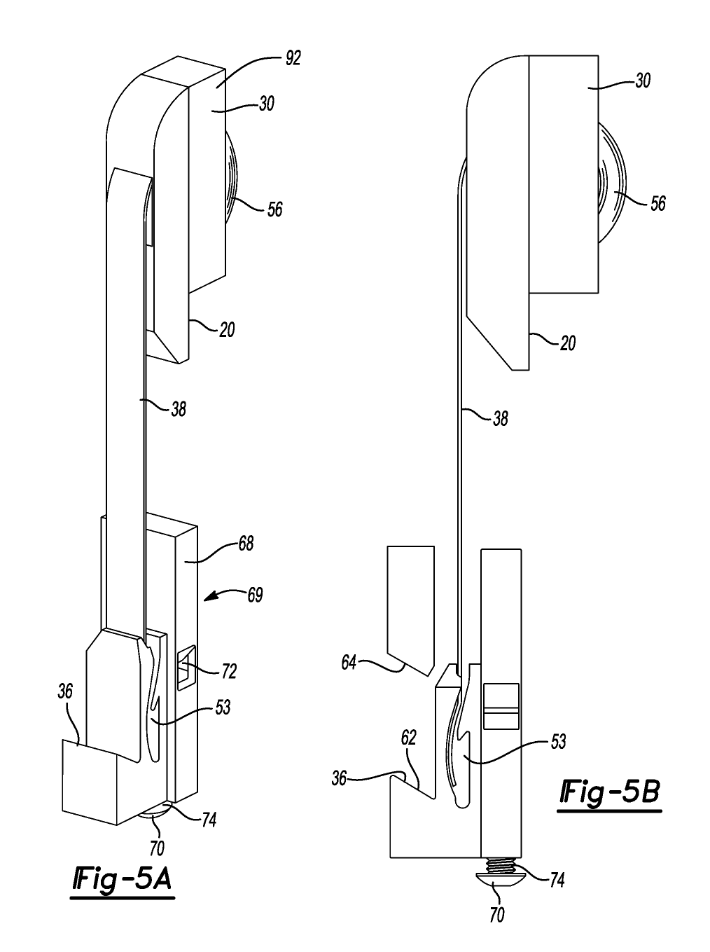

FIGS. 5A and 5B represent views of the spring counter balance 20 according to an alternate teaching. The spring counter balance 20 has an alternate sash support 68 having an alternate locking mechanism 69. The alternate locking mechanism 69 has a rotatable member 70 which functions to deploy a pair of engagement members 72. The engagement members 72 couple to both the first and second side bearing surfaces 26, 28 of the frame 22. While the side bearing surfaces 26 and 28 are shown generally perpendicular to the first bearing surface 24, it is envisioned that the engagement member could be deployed into an aperture in the bearing surface 24. The engagement members can have textured surfaces to dig into the first and second side bearing surfaces 26, 28.

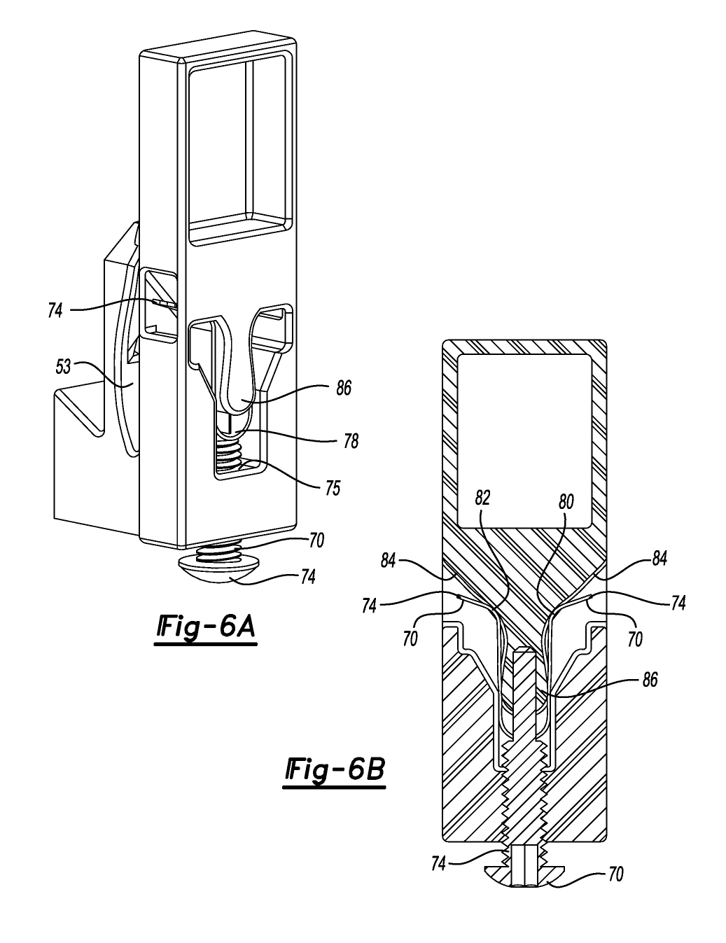

As shown in FIGS. 6A and 6B, the alternate sash support 68 has a rotatable member 70 that can be a threaded screw 74. The threaded screw 74 is rotatably engaged with a threaded hole 75 within the alternate sash support 68. The pair of rotatable members 70 is coupled to a u-shaped spring metal member 78.

As shown in FIG. 6B, rotation of the screw 74 forces the u-shaped member pair of sloped engaged surfaces 80, 82 into a sloped bearing surfaces 84. The screw 74 can have a bearing surface generally perpendicular to the axis of rotation which engages a bearing surface in the u-shaped spring member 78. Rotation of the screw 74 rotates the rotatable and/or translates members 70 into the window frame. The rotatable or translated members 70 are then frictionally engaged with the frame 22 or are positioned within an aperture defined in the frame. As the u-shaped member is formed of metal such as spring steel, the members 70 are pulled out of the window fame upon reverse rotation of the screw, thus allowing the sash support 68 to move freely within the track.

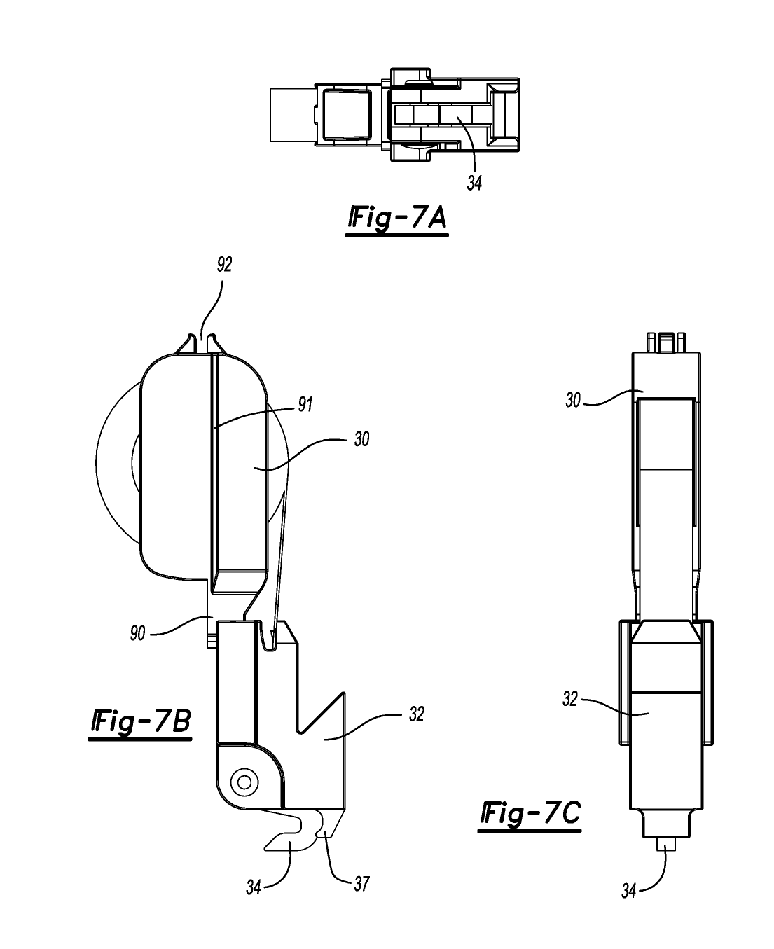

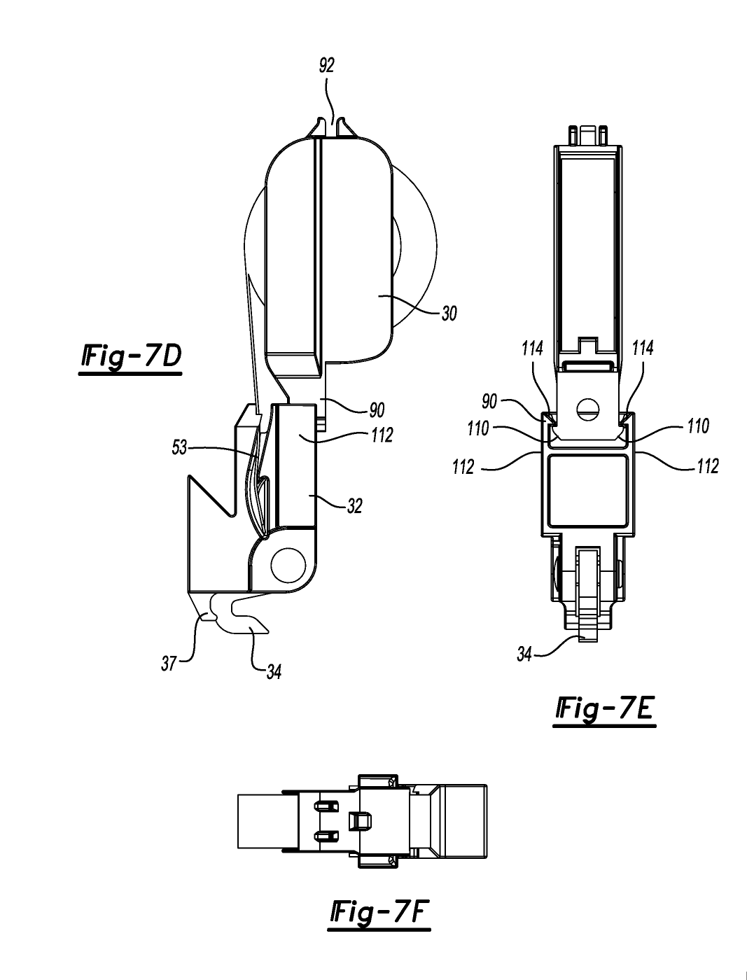

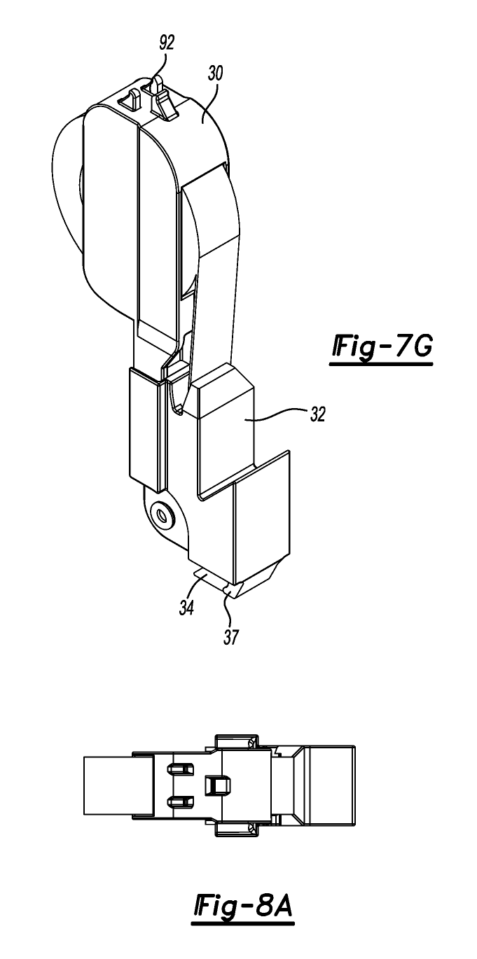

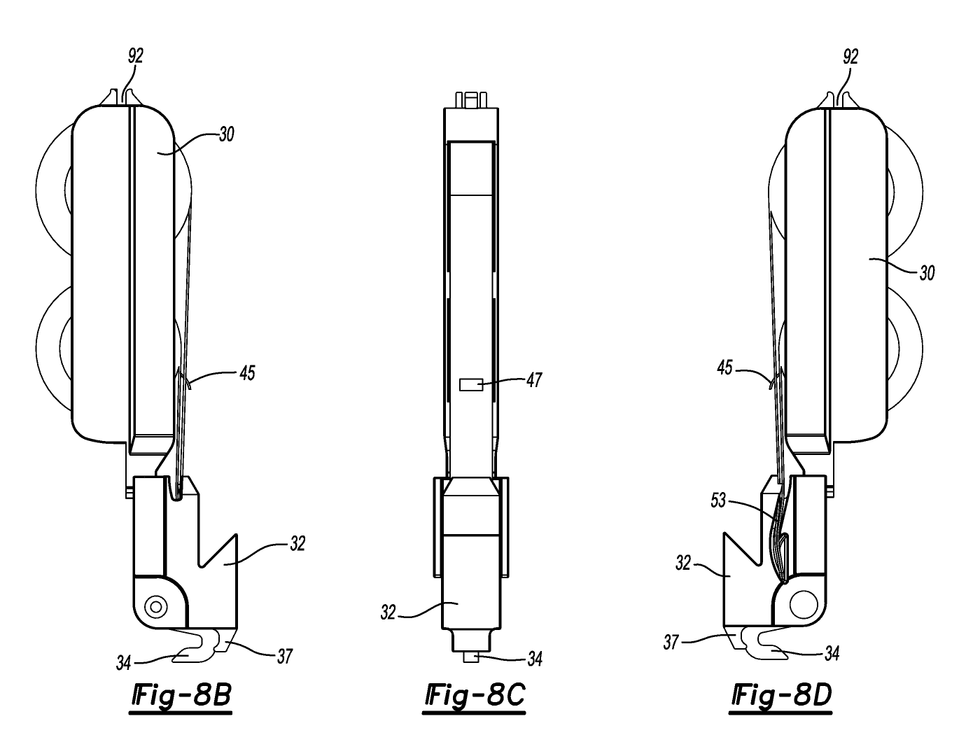

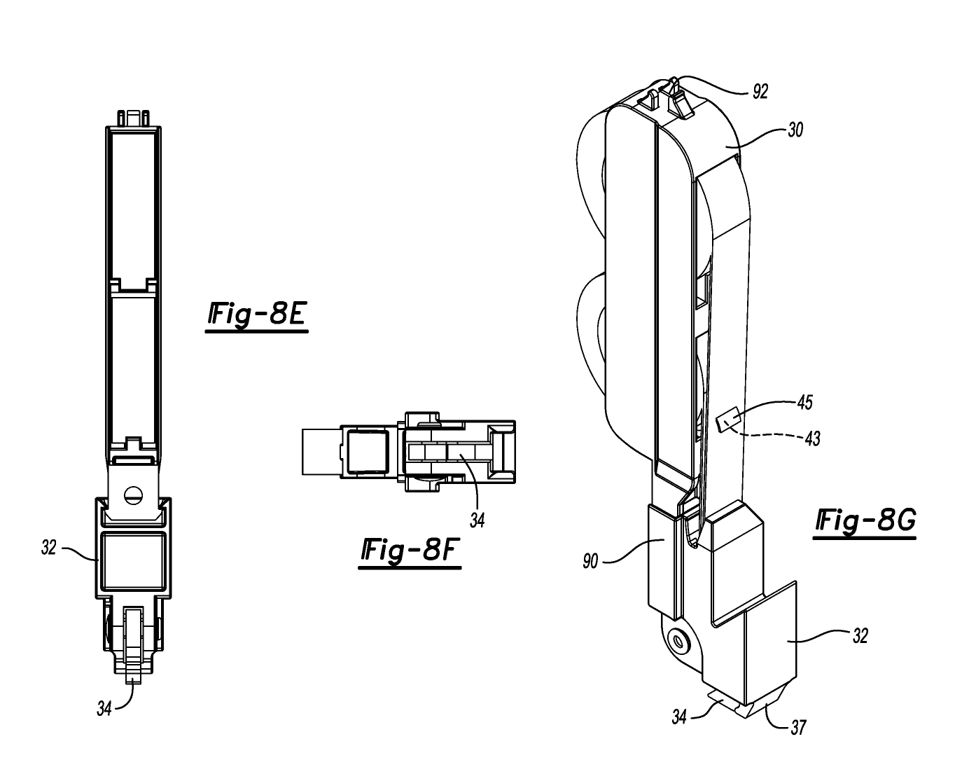

FIGS. 7A-7G and 8A-8G represent views of single and dual spring counter balance assemblies. As shown, the spring housing 30 can be coupled to the sash support 32 for shipment. Not only are the spring housing 30 and sash support 32 coupled by the spring 38, but components 30, 32 can also be coupled by a selectively engageable locking connection 90. As shown in FIG. 7E and throughout the figures, the selectively engageable locking connection 90 attaches the spring housing 30 and sash support 32 at a removably connectable joint formed by outwardly extending protrusions 110 on the lower portion of the spring housing 30 and a receptacle portion at the upper end of the sash support 32. The receptacle portion can be formed by a plurality of side walls 112 that include inwardly extending retaining members 114 which engage the protrusions 110. The locking connection 90 can be engaged laterally, such as by sliding the side walls 112 and retaining member 114 of the sash support 32 over the protrusions 110 on the lower portion of the spring housing 30. Alternatively, the locking connection 90 can be engaged axially such as by inserting the protrusions 110 on the lower portion of the spring housing 30 into the receptacle portion at the upper end of the sash support 32. Consequently, the locking connection 90 can be engaged to connect the spring housing 30 and sash support 32 during shipping. In addition, the locking connection 90 can be engaged to connect the spring housing 30 and sash support when the sash is in a fully opened condition. It can therefore be appreciated that the locking connection 90 provides supplementary support for the sash when the spring 38 is in a fully retracted condition. On a first surface of the spring housing is a pair of flanges 92 which engage the carrier aperture 41.

FIG. 7A represents a bottom view of the single spring counter balance assembly. Shown is the location of the locking feature 34 which is rotatable fixed to the sash support 32 via a pin (not shown). The sash support 32 is configured to frictionally support the locking feature 34 into an unexposed position until needed. When a consumer needs to lock the sash support into the frame, the consumer can rotate the locking member about the pin using their finger. Optionally, under gravity, the locking mechanism will rotate into the aperture formed in the frame to lock the sash assembly into position.

FIGS. 7B and 7C represent side and edge views of the interaction of the spring housing 30 and sash support 32 in their shipping configuration. The locking connection 90 can be uncoupled to allow the fixation of the spring housing 90 to the frame 22. Also shown is a support surface 91 which is configured to bear against the frame 22 when the spring housing is coupled to the frame 22.

FIGS. 8A-8G represent an alternate two spring counter balance 20. The spring support 30 is configured to couple two coiled leaf springs into place. As described above, the springs are rotatably supported in the spring support 30. The second end of both springs can be coupled to the sash support 32 via the slot 53. The springs can be coupled together using a tab 45 from a first spring, which is interleaved with a slot 47 formed in the second spring.

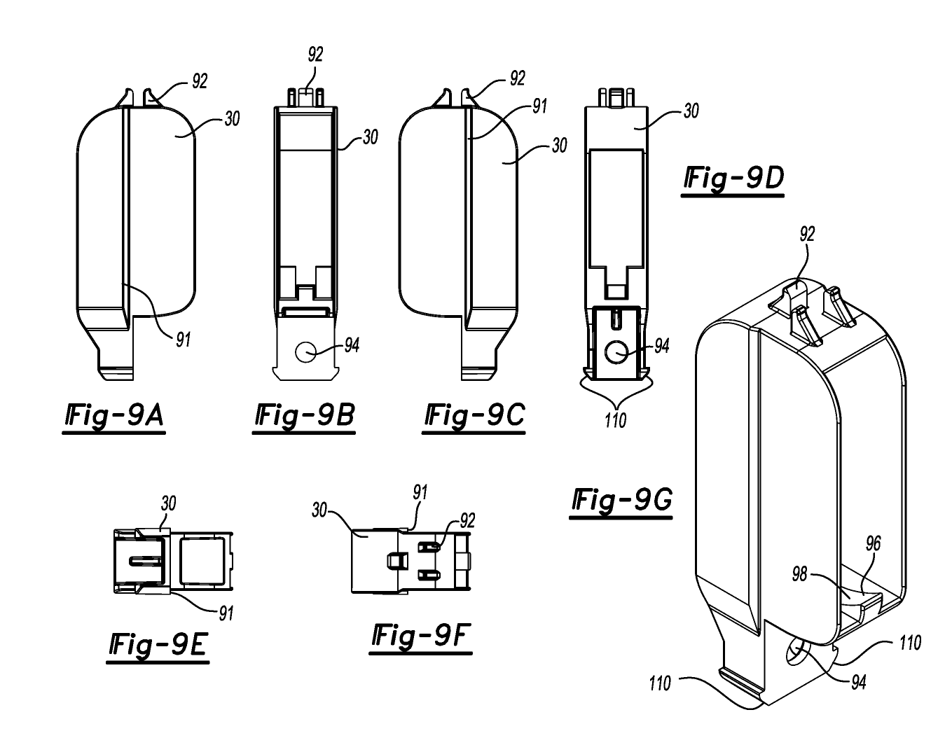

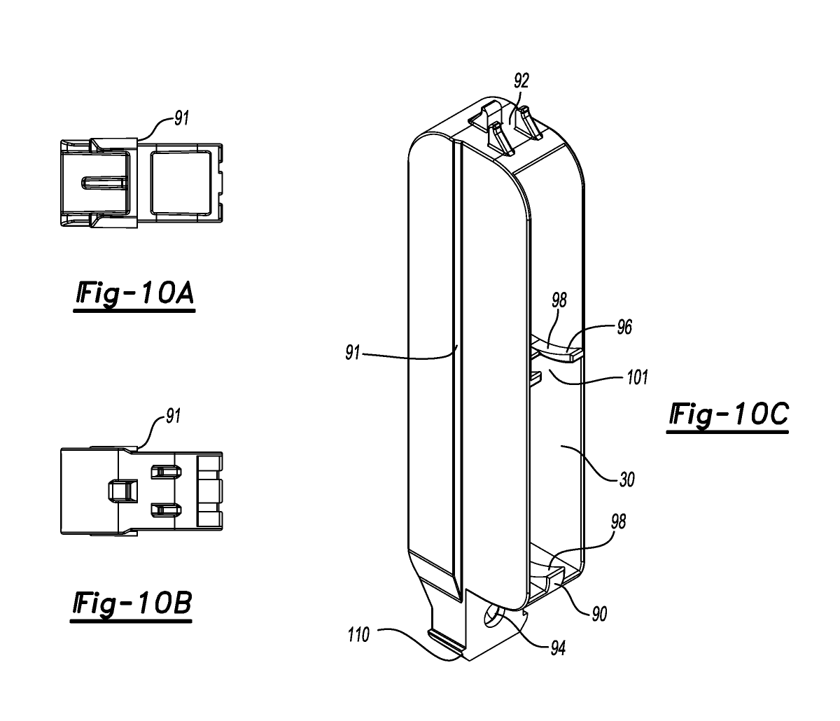

As shown in FIGS. 9A-10C, the spring housing 30 defines a fastener accepting aperture 94 which accepts a fastener to couple the spring housing 30 to the frame 22. Also shown is exemplar coupling flanges 92 which are used to position the spring housing into the aperture defined in the frame surface 24. As best seen in FIG. 9G, the spring housing can define a curved ramp surface 96 on a spring supporting flange 98. The surface facilitates the proper rotation of the coiled spring 38 within the spring housing during extraction or retraction of the spring caused by movement of the sash support 32.

As shown in FIGS. 10A-10C, the two-spring spring housing 30 can have a pair of internal spring support flanges 98 having curved ramped surfaces 96. One of the ramped surfaces 96 can have a slot 101 defined therein to accommodate the movement of the spring 38.

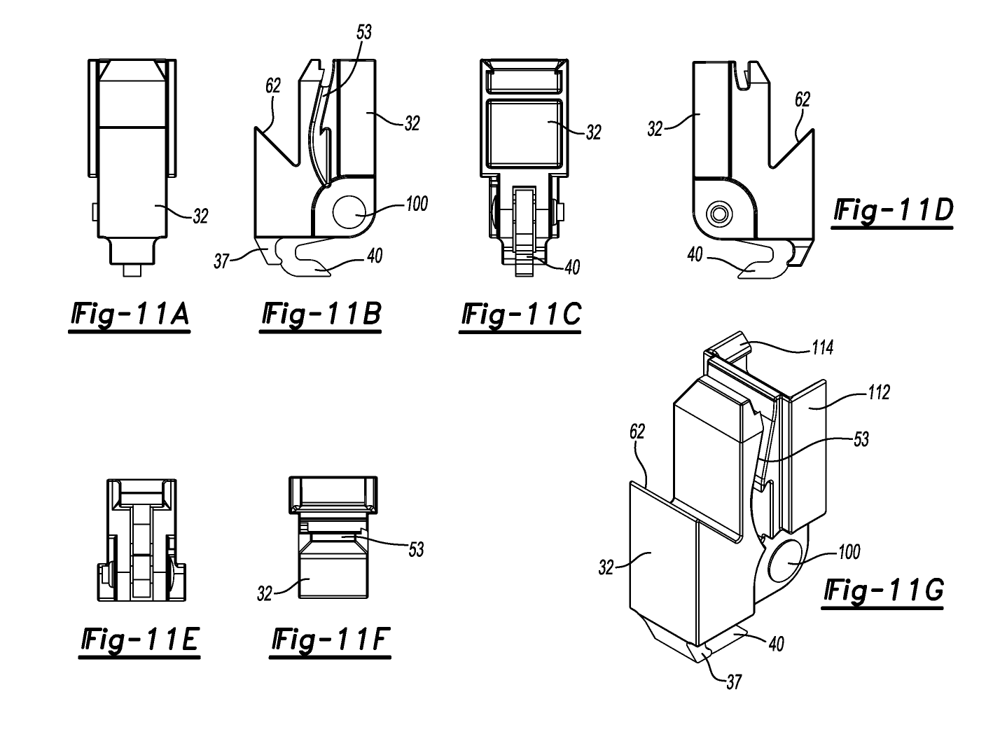

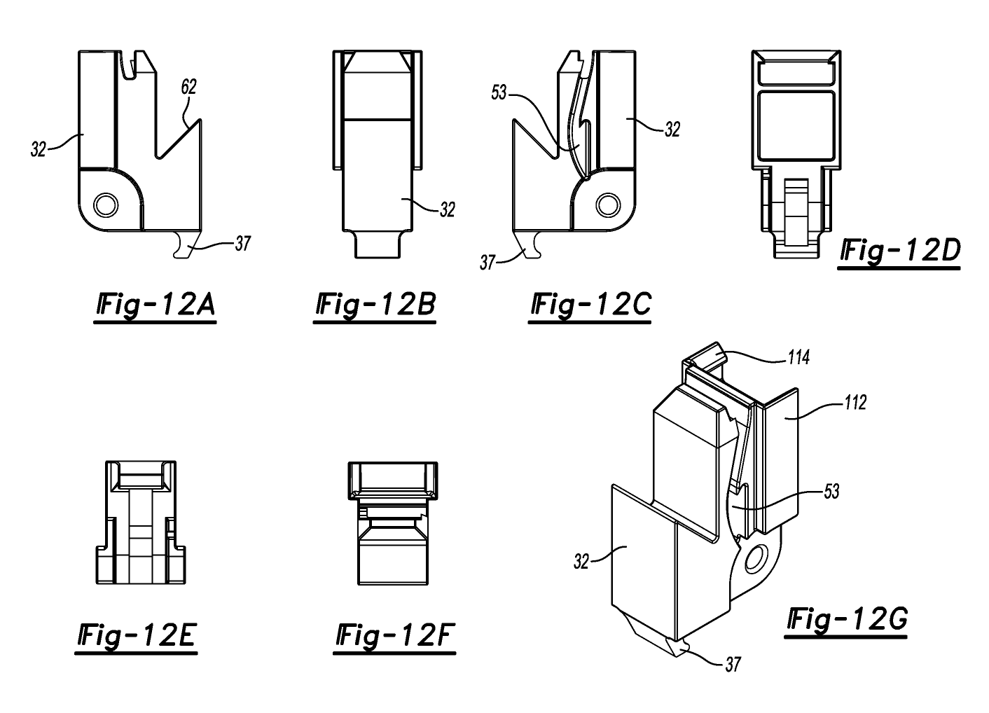

FIGS. 11A-12G represent alternate views of the sash support 32. Shown are the members with and without the locking feature 46 that are held into the sash support using a pin 100.

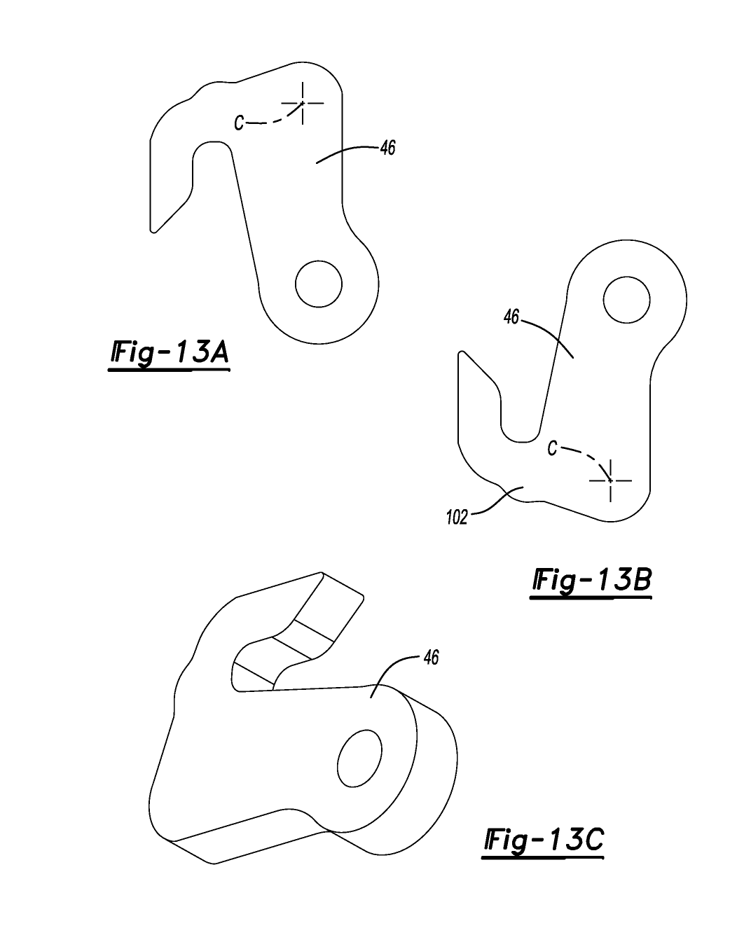

FIGS. 13A-13C represent a version of the rotatable locking feature 46. The locking feature is a hook member having a surface which engages the aperture in the window frame. Also shown is a bump 102 which engages a lock 37 in the sash support 32 which holds the hook in an undeployed position. Additionally, the rotatable locking feature 46 can have a defined center of gravity C, which allows for the rotation of the locking member into the frame under the force of gravity.

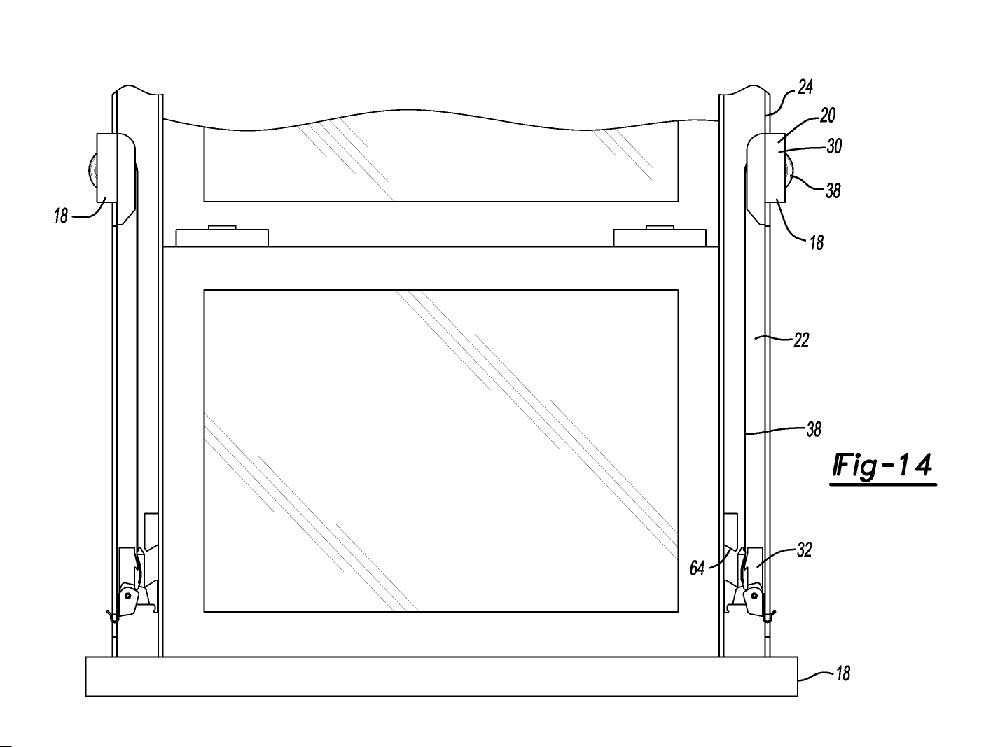

FIG. 14 depicts a window assemble according to the present teachings. Disposed within the window jamb is at least one movable sash, and associated sash support 32. As described above, there is shown a window support assembly 18. The window assembly has a frame 22 which slidably supports a sash. To prevent the effects of gravity on the sash, a spring counter balance 20 is provided. The spring counter balance 20, which is shown in a retracted position, is coupled to the window frame 22 and provides forces to support the sash.

The spring counter balance 20 is positioned within the frame 22, being fixably coupled to a first bearing surface 24. In this regard, a portion of the spring counter balance 20 is positioned within a carrier aperture 41 defined within the first bearing surface 24. The spring counterbalance 20 can be fixed within the aperture 41 using flanges and/or one or more fasteners.

The spring housing 30 is positioned with the carrier aperture 41, functions to couple the spring 38 to the first bearing surface 24 and, as described below, has features to facilitate the coupling and reduce the profile of the spring counter balance 20. A portion of the spring 38 can rotate within the housing on a curved bearing surface to allow extraction of the spring during movement of the sash. As the sash moves within the frame, the extracted portion of the spring 38 travels with the sash. In this regard, the spring and sash travel proportionally, so there is no longitudinal relative movement of the spring 38 with respect to the sash. This significantly reduces the amount of friction between the components and reduces the amount of damage which may be caused by movement of the spring 38.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A set of components adapted for constructing a window balance assembly for a window frame, the set of components comprising:
a spring module including a housing engaging a first portion of a spring member, the housing having a first engagement feature disposed at a first end and a second engagement feature disposed at a second end opposite the first end; and
a carrier module configured to receive a portion of a window sash and comprising third and fourth engagement features, the third engagement feature being selectively connectable with the first engagement feature, and the fourth engagement feature configured to selectively engage the window frame.

2. The set of components of claim 1, wherein the fourth engagement feature is configured to selectively engage an aperture defined by the window frame.

3. The set of components of claim 2, wherein the fourth engagement feature of the carrier module a rotatable hook.

4. The set of components of claim 1, wherein the fourth engagement feature is a selectively deformable u-shaped deformable member.

5. The set of components of claim 4, wherein the fourth engagement feature includes a rotatable member adapted to apply forces to a portion of the u-shaped member to translate a portion thereof into the frame.

6. The set of components of claim 1, wherein the carrier module includes a spring engagement feature adapted to receive a second portion of the spring member.

7. The set of components of claim 1, wherein the third engagement feature includes a pair of projections.

8. The set of components of claim 7, wherein the first engagement feature defines a pair of slots sized and shaped to selectively receive the projections.

9. A method of installing a window balance assembly onto a window jamb, the method comprising:
inserting a spring module into a jamb channel of the window jamb through a cutout disposed between first and second ends of the jamb channel;
detaching a carrier module from the spring module; and
connecting the carrier module to a window sash.

10. The method of claim 15, further comprising fixing the spring module to the jamb channel with a fastener.

11. The method of claim 15, wherein detaching the spring module from the carrier module includes disconnecting a first engagement feature extending from a body of the carrier module with a second engagement feature of a housing of the spring module.

12. The method of claim 15, further comprising connecting the spring module to the carrier module by connecting an uncurled end of a spring member extending from the spring module to an attachment feature of the carrier module.

13. The method of claim 9, further comprising coupling the carrier module to the jamb by engaging a fourth coupling feature.

14. The method of claim 9, further comprising rotating a member adapted to apply forces to a portion of fourth coupling feature to translate a portion thereof into the frame.

15. The method of claim 14, wherein applying forces to a portion of the fourth coupling feature includes applying forces to a portion of a deformable u-shaped member.

16. The method of claim 9, further comprising positioning a portion of the spring module through an aperture defined in the jamb.

17. The method of claim 15, connecting the carrier module to a window sash includes supporting a first surface of the sash with a second surface on the carrier module.

18. A window balance assembly for a window frame, comprising:
a spring member having first and second portions;
a spring module including a housing engaging the first portion of a spring member, the housing having a first engagement feature disposed at a first end configured to engage an aperture defined in the window frame, and a second engagement feature disposed at a second end opposite the first end; and
a carrier module coupled to the second portion of the spring member, the carrier module being configured to support a portion of a window sash and comprising third and fourth engagement features, the third engagement feature being selectively connectable with the second engagement feature, and the fourth engagement feature configured to selectively engage the window frame.

19. The window balance of claim 18, wherein the fourth engagement feature is a rotatable hook configured to selectively engage an aperture defined by the window frame.

20. The set of components of claim 18, wherein the fourth engagement feature is a selectively deformable u-shaped deformable member.

21. The set of components of claim 20, wherein the fourth engagement feature includes a rotatable member adapted to apply forces to a portion of the u-shaped member to translate a portion thereof into the frame.
